(19) United States
(12) Patent Application Publication
(10) Pub. No.: US 2005/0140867 A1
(43) Pub. Date: Jun. 30, 2005

(54) Trans-reflecting type in plane switching mode liquid crystal display device having ferroelectric liquid crystal alignment layer

(76) Inventor: Su-Seok Choi, Gyeonggi-Do (KR)

Correspondence Address: MCKENNA LONG & ALDRIDGE LLP, 1900 K STREET, NW, WASHINGTON, DC, 20006, US

(21) Appl. No.: 10/960,933

(22) Filed: Oct. 12, 2004

(30) Foreign Application Priority Data
Dec. 30, 2003 (KR) 2003-100867

(51) Int. Cl. G02F 1/1335

(52) U.S. Cl. 349/114

(57) ABSTRACT

Disclosed is a transreflective in-plane switching mode liquid crystal display (LCD) device. The LCD device includes first and second substrates including a plurality of pixels, each pixel having a transmitting unit and a reflecting unit, wherein the first substrate includes a first electrode and the second substrate includes a second electrode in each of the transmitting unit and the reflecting unit for applying voltages; first and second passive alignment layers over the first and second electrodes, respectively; first and second ferroelectric liquid crystal alignment layers on the first and second passive alignment layers, respectively; and a liquid crystal layer between the first and second substrates.

This application claims the benefit of Korean Patent Application No. 2003-100867, filed on Dec. 30, 2003, which is hereby incorporated by reference for all purposes as if fully set forth herein.

### BACKGROUND OF THE INVENTION

1. Field of the Invention

The present invention relates to a liquid crystal display (LCD) device and, more particularly, to a transreflective in-plane switching mode LCD device in which the transmittance of the transmitting unit is substantially the same as that of the reflecting unit.

2. Discussion of the Related Art

With the development of various portable electronic devices such as mobile phones, PDAs and notebook computers, the demand for a light, thin and small flat panel display device is recently increasing. Researches are actively being conducted for flat panel display devices such as an LCD (Liquid Crystal Display), a PDP (Plasma Display Panel), an FED (Field Emission Display), a VFD (Vacuum Fluorescent Display), or the like. Of them, the LCD device receives much attention due to its simple mass-production technique, easy driving system and high picture quality.

The LCD device has various display modes according to the arrangements of liquid crystal molecules. A TN-mode (Twisted Nematic Mode) LCD device has widely been used due to such advantages as high contrast ratio, rapid response time and low driving voltage. In such a TN mode LCD device, when a voltage is applied to liquid crystal molecules horizontally aligned with two substrates, the liquid crystal molecules rotate and then are almost vertically aligned with the two substrates. Accordingly, when a voltage is applied, the viewing angle of the TN mode LCD device becomes narrow due to a refractive anisotropy of the liquid crystal molecules.

To solve such a narrow viewing angle problem, other modes of the LCD device have recently been proposed. Among them, an IPS-mode (In-Plane Switching Mode) LCD device is actually being mass-produced. The IPS-mode LCD device aligns liquid molecules on a plane by forming at least a pair of electrodes in parallel with each other in a pixel and then forming a horizontal electric field substantially parallel with the surface of the substrate between the two electrodes.

FIG. 1 illustrates a structure of an IPS-mode LCD device according to a related art. Referring to FIG. 1, a gate line 3 crosses a data line 4 to define a pixel of an LCD panel 1. Although only one pixel, (n, m)th pixel, is illustrated in FIG. 1, the LCD panel 1 has ‘n’ number of the gate lines 3 and ‘m’ number of the data lines 4, and thus has ‘n×m’ number of pixels.

A thin film transistor 10 is formed near the crossing of the gate line 3 and the data line 4. The thin film transistor 10 includes: a gate electrode 11 to which a scan signal from the gate line 3 is applied; a semiconductor layer 12 formed on the gate electrode 11 and forming a channel layer, which is activated when the scan signal is applied; a source electrode 13 and a drain electrode 14 formed on the semiconductor layer 12, to which an image signal is applied through the data line 4. The thin film transistor 10 having such a construction applies the image signal inputted from the outside to a liquid crystal layer.

Each pixel includes a plurality of common electrodes 5 and a plurality of pixel electrodes 7 substantially parallel with the data lines 4. In addition, a common line 16 connected to the common electrodes 5 is disposed in a middle of the pixel, and a pixel electrode line 18 connected to the pixel electrodes 7 is disposed on the common line 16 and overlaps the common lines 16.

In the IPS-mode LCD device having such a construction, liquid crystal molecules are substantially aligned in parallel with the common electrodes 5 and the pixel electrodes 7. When the thin film transistor 10 operates and the image signal is applied to the pixel electrode 7, a horizontal electric field substantially parallel with a surface of the liquid crystal panel 1 is generated between the common electrodes 5 and the pixel electrodes 7. Then, the liquid crystal molecules rotate on the same plane by the horizontal electric field, so that a grey inversion phenomenon, which is resulted from the refractive anisotropy of the liquid crystal molecules in the TN-mode LCD device, can be prevented.

FIGS. 2A and 2B are cross-sectional views of the related art IPS mode LCD device. FIG. 2A is a cross-sectional view taken along the line I-I′ of FIG. 1, and FIG. 2B is a cross-sectional view taken along line the II-II′ of FIG. 1. As shown in FIG. 2A, the gate electrode 11 is formed on a first substrate 20, and a gate insulating layer 22 is formed on the gate electrode 11. Then, the semiconductor layer 12 is formed on the gate insulating layer 22, and the source electrode 13 and the drain electrode 14 are formed on the semiconductor layer 12. Moreover, a passivation layer 24 is formed over the first substrate 20.

A black matrix 32 and a color filter layer 34 are formed on a second substrate 30. The black matrix 32 is provided on the second substrate 30 to prevent light leakage, and is mainly formed on the thin film transistor 10 region and the regions between the pixels covering the gate and data lines, as shown in FIG. 2B. The color filter layer 34 including R (Red), B (Blue) and G (Green) color filters is provided to display colors. A liquid crystal layer 40 is formed between the first substrate 20 and the second substrate 30, completing the liquid crystal panel 1.

Referring to FIG. 2B, the common electrodes 5 are formed on the first substrate 20, the pixel electrodes 7 are formed on the gate insulating layer 22, and a horizontal electric field is generated between the common electrodes 5 and the pixel electrodes 7. At this time, the passivation layer 24 is formed on the gate insulating layer 22. The liquid crystal molecules of the liquid crystal layer 40 arranged in an initial align direction, which generally forms a predetermined angle to the extended directions of the common and pixel electrodes, rotate along the horizontal electric field to display images on the screen.

In the IPS-mode LCD device, a backlight is provided at a lower portion of the first substrate 20, and light incident upon the LCD panel 1 from the backlight passes through the liquid crystal layer 40, thereby displaying images on the screen.

In general, the LCD device is mainly used for portable electronic devices such as laptop computers, cellular phones, or the like. Accordingly, efforts are being made to extend the usage time of the portable electronic devices without an outside electrical source. It is the backlight that consumes most of the power in the LCD device. Therefore, researches are actively being conducted to reduce power consumption of the backlight, but satisfactory results have not been achieved to date. The IPS-mode LCD device as well as the TN-mode LCD device suffer from such a problem.

### SUMMARY OF THE INVENTION

Accordingly, the present invention is directed to a transreflective in-plane switching mode liquid crystal display device that substantially obviates one or more of the problems due to limitations and disadvantages of the related art.

An advantage of the present invention is to provide a transreflective in-plane switching mode liquid crystal display in which the transmittance of the transmitting unit is substantially the same as that of the reflecting unit.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a liquid crystal display device includes first and second substrates including a plurality of pixels, each pixel having a transmitting unit and a reflecting unit, wherein the first substrate includes a first electrode and the second substrate includes a second electrode in each of the transmitting unit and the reflecting unit for applying voltages; first and second passive alignment layers over the first and second electrodes, respectively; first and second ferroelectric liquid crystal alignment layers on the first and second passive alignment layers, respectively; and a liquid crystal layer between the first and second substrates.

In another aspect of the present invention, a liquid crystal display device includes a ferroelectric liquid crystal alignment layer between first and second substrates, the first and second substrates having a pixel, the pixel having a transmitting unit and a reflecting unit; a liquid crystal layer between the first and second substrates; first and second electrodes in the transmitting unit for applying a first voltage to the liquid crystal layer in the transmitting unit; and third and fourth electrodes in the reflecting unit for applying a second voltage to the liquid crystal layer in the reflecting unit, the first voltage is different from the second voltage.

In yet another aspect of the present invention, a liquid crystal display (LCD) device includes a substrate having first and second regions; an alignment layer including ferroelectric liquid crystal molecules, the ferroelectric liquid crystal molecules rotating by a first angle θ₁ in the first region, the ferroelectric liquid crystal molecules rotating by a second angle θ₂ in the second region, the first angle θ₁ different from the second angle θ₂; and a liquid crystal layer contacting the ferroelectric liquid crystal molecules, liquid crystal molecules of the liquid crystal layer rotating according to the rotation of the ferroelectric liquid crystal molecules.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a plan view of an in-plane switching mode liquid crystal display device according to a related art;

FIG. 2A is a cross-sectional view taken along the line I-I′ of FIG. 1;

FIG. 2B is a cross-sectional view taken along the line II-II′ of FIG. 1;

FIG. 3 is a schematic view of a transreflective in-plane switching mode liquid crystal display device;

FIG. 4 illustrates a structure of an in-plane switching mode liquid crystal display device having an alignment layer including a ferroelectric liquid crystal;

FIGS. 5A and 5B illustrate rotation of ferroelectric liquid crystal molecules when a voltage is applied; and

FIG. 6 is a schematic view illustrating a structure of a transreflective IPS-mode LCD device according to the present invention.

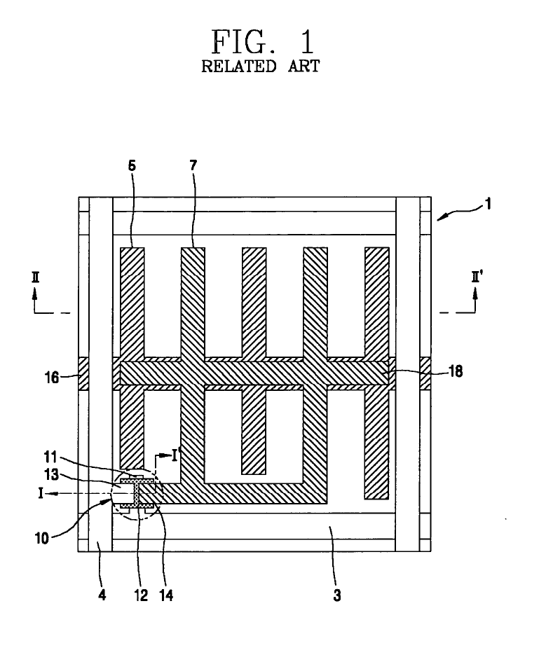

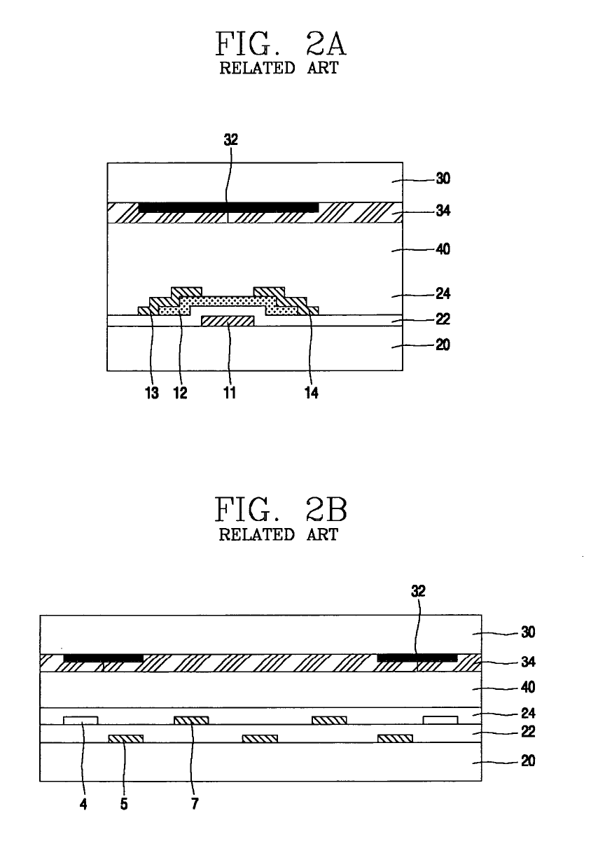

### DETAILED DESCRIPTION OF THE ILLUSTRATED EMBODIMENTS

Reference will now be made in detail to an embodiment of the present invention, example of which is illustrated in the accompanying drawings.

An IPS-mode LCD (In-Plane Switching mode Liquid Crystal Display) device according to the present invention can be used in portable electronic devices with minimized power consumption. To this end, a transreflective IPS-mode LCD device is disclosed in the present invention.

In general, the transreflective LCD device has the advantages of a transmitting-type LCD device as well as the advantages of a reflecting-type LCD device. The reflecting-type LCD device uses external light as a light source. As a result, the reflecting-type LCD device consumes less power, because about 70 % of the power consumption of LCD devices results from the backlight unit. In addition, because the reflecting-type LCD device does not have a backlight unit, the thickness and weight of the LCD device can be decreased. Thus, the reflecting-type LCD can display good quality images with minimum power consumption. However, it is disadvantageous in that it cannot be used without external light.

The transreflective LCD device is a combination of the reflecting-type LCD device and the transmitting-type LCD device. The transreflective LCD device can be used with and without external light, thereby minimizing the power consumption.

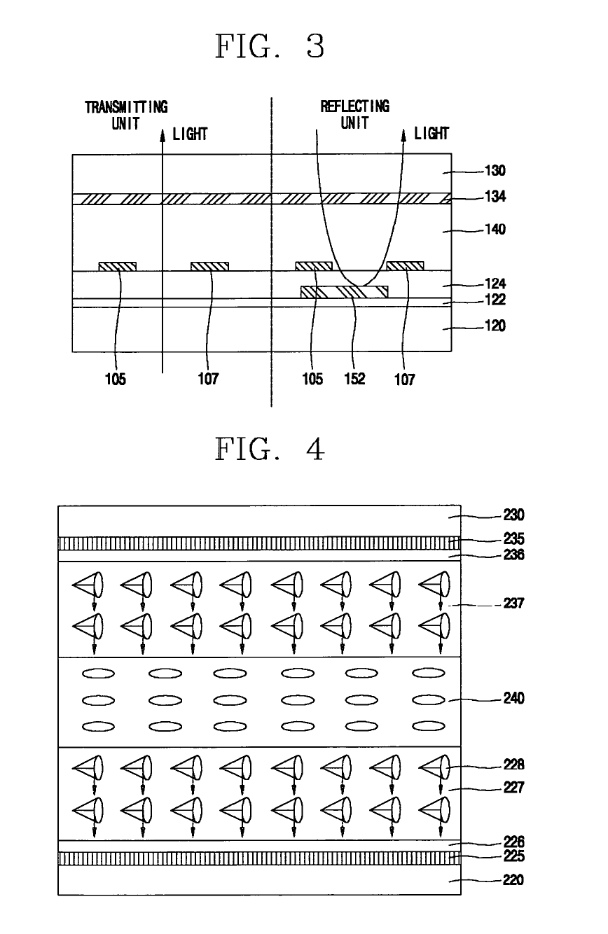

FIG. 3 is a schematic view of a transreflective IPS-mode LCD device. Referring to FIG. 3, the transreflective LCD device provided with a transmitting unit and a reflecting unit in one pixel displays images using the transmitting unit and the reflecting unit depending on the users' demands. The reflecting unit includes a reflector 152 for reflecting the light from the outside. In the reflecting unit, the light from the outside passes through the liquid crystal layer 140, then is reflected on the reflector 152, and passes through the liquid crystal layer 140 again, thereby displaying images. On the other hand, the transmitting unit transmits the light from the backlight (not shown) through the liquid crystal layer 140, thereby displaying images.

Meanwhile, the transmittance T of the IPS-mode LCD device is defined by the following equation 1:

$$T = {sin}^{2} 2 {θsin}^{2} ( \frac{π d Δ n}{λ} ) \qquad [ equation 1 ]$$

Here, θ is a rotation angle of the liquid crystal molecules with respect to an axis of a polarizing plate, d is a cell gap, Δn is the refractive anisotropy of the liquid crystal molecules, and λ is a wavelength of light. Referring to equation 1, the transmittance T of the LCD device varies with the refractive anisotropy Δn and the rotation angle θ of the liquid crystal molecules (namely, transmittance T is determined by Δn and θ). The transmitting and reflecting units of the transreflective ]PS-mode LCD device share the same liquid crystal layer, and thus the transmitting unit and reflecting unit have the same refractive anisotropy Δn. Accordingly, variables determining the transmittance T of the transmitting unit and the reflecting unit of the transreflective IPS-mode LCD device are the cell gap (d) and the rotation angle θ.

However, the cell gap d does not simply mean a gap between the first substrate 120 and the second substrate 130 or the thickness of the liquid crystal layer 140, but means a path of the liquid crystal layer 140, through which light substantially proceeds. In the transmitting unit, the light from the backlight passes through the liquid crystal layer 140 once, while the external light passes through the liquid crystal layer 140 twice in the reflecting unit. Accordingly, a cell gap d1 of the transmitting unit is equal to d, while a cell gap 2 of the reflecting unit is equal to 2d. That is to say, the cell gap d2 of the reflecting unit is twice as much as the cell gap d1 of the transmitting unit (d2=2d1). The difference between the cell gaps d1 and d2 results in the difference between the transmittances T of the transmitting unit and the reflecting unit, which raises a problem of the transreflective IPS-mode LCD device.

In order to reduce the difference in the cell gaps between the transmitting unit and the reflecting unit and to make the transmittance T of the transmitting unit the same as that of the reflecting unit, a method is suggested in which the cell gap of the transmitting unit is increases by removing the gate insulating layer 122 and the passivation layer 124 to extend the light path. However, in this case, the extended light path (namely, the cell gap) in the transmitting unit is not the same as the cell gap of the reflecting unit, and the fabrication process and structure of the device become more complicated due to the additional process of removing the gate insulating layer 122 and the passivation layer 124.

The present invention discloses a transreflective IPS-mode LCD device that has simple manufacturing process and structure. In a transreflective IPS-mode LCD device according to the present invention, the transmittance of the transmitting unit is substantially the same as the transmittance of the reflecting unit. To this end, a transreflective IPS-mode LCD uses an alignment layer including a ferroelectric liquid crystal, such that liquid crystal molecules are switched in parallel with substrates. By varying degrees of the switching of the liquid crystal molecules in the transmitting unit and the reflecting unit, which means, by varying the rotation angles of the liquid crystal molecules, the transmittance of the transmitting unit can be substantially the same as the transmittance of the reflecting unit.

When an electric field or a magnetic field is applied to the alignment layer including a ferroelectric liquid crystal, a spontaneous polarization occurs in a predetermined direction. For example, when a voltage is applied, the ferroelectric liquid crystal molecules of the alignment layer rotate along a virtual cone on a plane, and according to this rotation, the liquid crystal molecules of the liquid crystal layer rotate on the same plane. This phenomenon will be described in more detail.

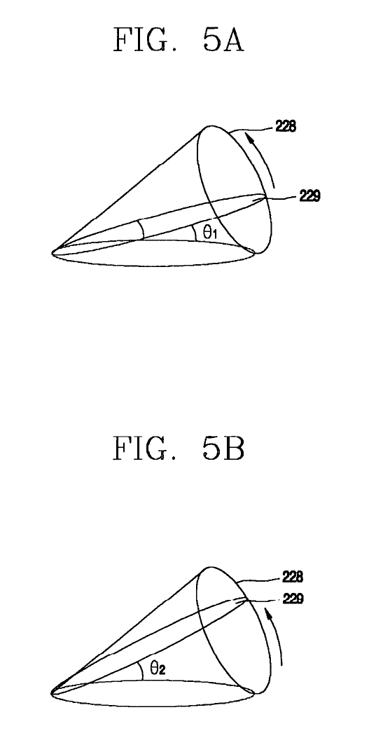

FIG. 4 illustrates a structure of an in-plane switching mode liquid crystal display device having an alignment layer including a ferroelectric liquid crystal. Referring to FIG. 4, a first electrode 225 and a second electrode 235 made of a transparent conductive material, such as Indium Tin Oxide (ITO) or Indium Zinc Oxide (IZO), are formed on a first substrate 220 and a second substrate 230. A first passive alignment layer 226 and a second passive alignment layer 236 including polyimide are formed on the first electrode 225 and the second electrode 235, respectively. The passive alignment layers 226 and 236 undergo an alignment process such as a rubbing process so as to form a pretilt angle.

A first ferroelectric liquid crystal layer 227 and a second ferroelectric liquid crystal layer 237 are formed on the first passive alignment layer 226 and the second passive alignment layer 236, respectively. The ferroelectric liquid crystal alignment layers 227 and 237 include a CDR (Continuously Director Rotate)-based liquid crystal, an anti-ferroelectric liquid crystal, a Surface Stabilized Ferroelectric-based LC, ferroelectric liquid crystal polymer or monomer, or a PS(Polymer Stabilization) ferroelectric liquid crystal. The CDR-based liquid crystal has advantages of a fast response time, a wide viewing angle and a relatively small capacitance. As a result, it is advantageous to display moving images.

The spontaneous polarizations of the liquid crystal molecules of the ferroelectric alignment layers 227 and 237 are randomly distributed. Accordingly, the randomly distributed spontaneous polarization should be arranged in a desired direction. To this end, an electric field or a magnetic field is applied to the liquid crystal molecules of the ferroelectric alignment layers 227 and 237. At this time, the spontaneous polarizations of the first and second ferroelectric alignment layers 227 and 237 are arranged in a direction toward the first substrate 220. That is, the spontaneous polarization of the first ferroelectric alignment layer 227 is arranged in the same direction (in the direction towards the first substrate) as the spontaneous polarization of the second ferroelectric alignment layer 237, as illustrated in FIG. 4.

In addition, by adding a photo-polymeric monomer in the ferroelectric liquid crystal of the alignment layers 227 and 237 or by adding double bonding to an end group of the ferroelectric liquid crystal in the alignment layers 227 and 237, a photo-curing reaction can be carried out. For the photo-curing reaction, light such as ultraviolet ray is irradiated onto the alignment layers 227 and 237, and thus a polymer network is formed by a photo-polymeric reaction in the alignment layers 227 and 237.

Then, a liquid crystal layer 240 including a negative nematic liquid crystal, which has negative permittivity anisotropy, is formed between the first and second ferroelectric alignment layers 227 and 237. However, a positive nematic LC can also be used for the liquid crystal layer in the present invention.

In the LCD device having such a construction, when a voltage is applied between the first electrode 225 and the second electrode 235, the ferroelectric liquid crystal molecules of the first and second ferroelectric alignment layer 227 and 237 rotate along a circumferential surface of a virtual cone 228. Meanwhile, the liquid crystal molecules of the liquid crystal layer 240 interact with the ferroelectric liquid crystal molecules of the first and second ferroelectric alignment layers 227 and 237, and are arranged in the substantially same direction as the ferroelectric liquid crystal molecules. Accordingly, the ferroelectric liquid crystal molecules of the first and second ferroelectric alignment layers 227 and 237 rotate along the virtual cone 228 by a voltage applied to the first and second electrodes 225 and 235, so that the liquid crystal molecules in the liquid crystal layer 240 is switched on the same plane.

The amount of light passing through the liquid crystal layer 240 changes by varying the voltage between the first electrode 225 and the second electrode 235. At this time, when an electric field or a magnetic field different from the initial polarization direction is applied, the ferroelectric liquid crystal molecules perform an in-plan switching by changing the direction of the spontaneous polarization. As a result, the liquid crystal molecules of the liquid crystal layer 240 adjacent to the ferroelectric crystal liquid molecules also perform an in-plane switching.

The liquid crystal molecules of the ferroelectric alignment layers 227 and 237 have a different rotating degree in the virtual cone 228 according to the applied voltages. As shown in FIG. 5A, when a voltage V1 is applied between the first substrate 220 and the second substrate 230, the ferroelectric crystal liquid molecules 229 rotate by θ₁, and thus the liquid crystal molecules of the liquid crystal layer 240 interacting with the ferroelectric liquid crystal molecules 229 also rotate by about θ₁ on the same plane. Meanwhile, as shown in FIG. 5B, when a voltage V2 (>V1) is applied between the first electrode 225 and the second electrode 235, the ferroelectric liquid crystal molecules 229 rotate by θ₂ (θ₂>θ₁), and thus the liquid crystal molecules of the liquid crystal layer 240 interacting with the ferroelectric liquid crystal molecules 229 also rotate by about θ₂ on the same plane.

As described above, the ferroelectric liquid crystal molecules of the first and second ferroelectric alignment layers 227 and 237 rotate at different angles according to the applied voltages, and the liquid molecules rotate on the same plane at different angles according to the applied voltages. This means that the liquid crystal molecules are aligned in different directions, when different voltages are applied between the first electrode 225 and the second electrode 235, and thus the total transmittance efficiency of the liquid crystal layer changes.

Using such features, the present invention embodies a structure of a transreflective IPS-mode LCD device. The transreflective IPS-mode LCD device has a simple structure, and the transmittance of light in the reflecting unit is substantially the same as the transmittance of light in the transmitting unit.

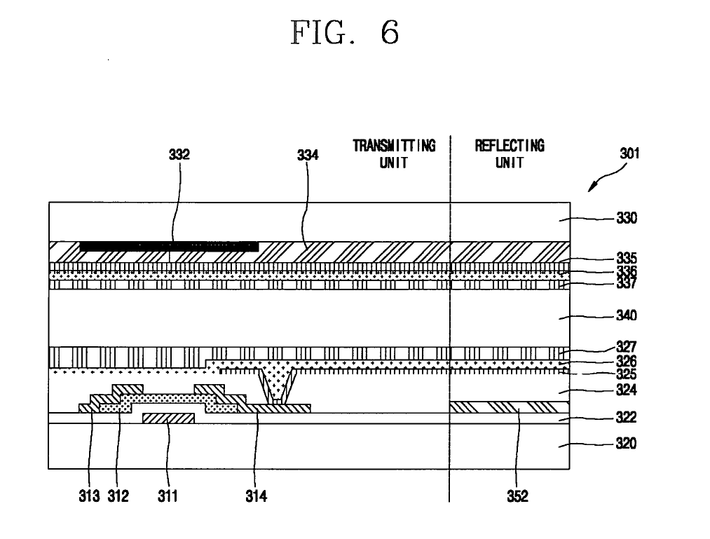

FIG. 6 is a schematic view illustrating a structure of a transreflective IPS-mode LCD device according to the present invention. For convenience of explanation, a pixel region is divided into a transmitting unit and a reflecting unit.

Referring to FIG. 6, in the transreflective IPS-mode LCD device according to the present invention, a gate electrode 311 is formed on a first substrate 320, and a gate insulating layer 322 is formed on the gate electrode 311. Then, a semiconductor layer 312 is formed on the gate insulating layer 322, and the source electrode 313 and the drain electrode 314 are formed on the semiconductor layer 312. At this time, although not shown in FIG. 6, an ohmic contact layer is formed on the semiconductor layer 312, which forms an ohmic contact to the source electrode 313 and the drain electrode 314. In addition, a passivation layer 324 is formed over the first substrate 320, and a first electrode 325 including ITO or IZO is formed on the passivation layer 324. At this time, the first electrode 325 is connected to the drain electrode 314 of a thin film transistor via a contact hole formed on the passivation layer 324.

Meanwhile, a metal layer 352 made of a high reflective metal such as aluminum Al is formed on the gate insulating layer 322 in the reflecting unit to form a reflector. A first passive alignment layer 326 such as polyimide is formed on the first electrode 325, and a first ferroelectric liquid crystal alignment layer 327 is formed on the first passive alignment layer 326.

A black matrix 332 and a color filter layer 334 are formed on a second substrate 330. The black matrix 332 is provided on the second substrate to prevent light leakage, and is mainly formed on a thin film transistor region and the regions between the pixels covering the gate line and data line regions), as shown in FIG. 6. The color filter layer 334 including R (Red), B (Blue) and G (Green) color filters is provided to display colors. A second electrode 335 including ITO or IZO is formed on the color filter layer 334, and a second passive alignment layer 336 is formed on the second electrode 335. Moreover, a second ferroelectric liquid crystal layer 337 is formed on the second passive alignment layer 336.

A liquid crystal layer 340 including a negative nematic liquid crystal is provided between the first substrate 320 and the second substrate 330, completing liquid crystal panel 301. At this time, although not shown in FIG. 6, a polarizing plate is attached to the first substrate 320 and the second substrate 330.

In the transreflective IPS-mode LCD having such a construction, when a voltage is applied to the first electrode 325 and the second electrode 335, the ferroelectric liquid crystal molecules of the first and second ferroelectric liquid crystal alignment layers 327 and 337 rotate along a virtual cone, so that the liquid crystal molecules of the liquid crystal layer 340 interacting with the ferroelectric liquid crystal molecules also rotate on a plane.

At this time, when the voltage applied to the transmitting unit is greater than the voltage applied to the reflecting unit, the liquid crystal molecules of the transmitting unit rotate more than those of the reflecting unit, and thus the rotation angle of the liquid crystal molecules in the transmitting unit becomes greater. The rotation angles of the liquid crystal molecules in the transmitting unit and the reflecting unit are such that the transmittance T of the transmitting unit becomes substantially the same as that of the reflecting unit by the equation 1, even with the difference in the cell gaps between the transmitting and reflecting units.

Voltages applied to the transmitting unit and the reflecting unit varies depending on the driving mode (transmitting mode or reflecting mode), and a separate electrode can be formed on and applied to each of the transmitting unit and the reflecting unit. The transreflective IPS-mode LCD device can operate in each driving mode. When a photo-sensor installed in the LCD device detects an amount of an external light greater than a set value, the LCD device operates in the reflecting mode in which the power supplied to the backlight unit is blocked and a reflecting mode voltage is applied to the electrodes 325 and 335. On the other hand, when the photo-sensor detects an amount of an external light less than the set value, the LCD device operates in a transmitting mode in which the backlight is on-state to supply light to the liquid crystal layer 340 and a transmitting mode voltage greater than the reflecting mode voltage is applied to the electrodes 325 and 335.

In addition, in the transreflective IPS-mode LCD device according to the present invention, after separate electrodes are formed in the transmitting unit and the reflecting unit, different voltages can be applied to each of the separate electrodes. To this end, one pixel has two thin film transistors to apply the different voltages to the transmitting unit and the reflecting unit.

As described above, in the transreflective IPS-mode LCD device according to the present invention, the transmittance T of the transmitting unit becomes substantially the same as that of the reflecting unit by applying different voltages to the transmitting unit and the reflecting unit. In the transreflective IPS-mode LCD device according to the related art, an electric field parallel with the surface of the substrates is applied to the liquid crystal layer, while an electric field perpendicular to the substrates is applied to the liquid crystal layer in the transreflective IPS-mode LCD device according to the present invention. In addition, in the transreflective IPS mode LCD device according to the related art, the liquid crystal molecules are switched parallel with the surface of the substrates by an electric field applied to the liquid crystal layer. However, in the present invention, the liquid crystal molecules are switched on the same plane by a rotation of the ferrorelectric liquid crystal molecules of the ferroelectric liquid crystal alignment layers. Accordingly, the switching method in accordance with the present invention is different from that of the related art.

As a result, the response time of the related art LCD device is directly proportional to the speed at which a nematic liquid crystal responds to an electric field, while the response time of the LCD device of the present invention is directly proportion to the rotation speed of the ferroelectric liquid crystal molecules, the speed at which the ferroelectric liquid crystal molecules respond to the electric field. The response time of the ferroelectric liquid crystal is tens to hundreds times faster than that of the nematic liquid crystal, and thus the nematic liquid crystal rapidly rotates as the ferroelectric liquid crystal molecules of the ferroelectric liquid crystal alignment layers responds to the applied voltages. Accordingly, the response time of the LCD device according to the present invention can be improved.

In the embodiment described above, the principles of the present invention are explained with an example of a transflective IPS mode LCD device. However, it should be understood that the principles of the present invention can be applied to other types or modes of LCD devices. In this embodiment, only one reflecting unit and one transmitting unit are formed in a pixel. However, it should be further understood that a plurality of reflecting units and a plurality of transmitting units can be formed in a pixel. Moreover, the ferroelectric liquid crystal alignment layers can include various types of liquid crystal such as a CDR (Continuously Director Rotate)-based liquid crystal, an anti-ferroelectric liquid crystal, or an SSFLC-based ferroelectric liquid crystal polymer.

As described in detail, in the present invention, the transmittance of the transmitting unit is substantially the same as that of the reflecting unit by using the alignment layer of ferroelectric liquid crystal and by applying different voltages to the transmitting unit and the reflecting unit. In addition, because the ferroelectric liquid crystal used in the present invention has a fast response time to an electric field, switching speed and response time can be improved.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A liquid crystal display (LCD) device comprising:
first and second substrates including a plurality of pixels, each pixel having a transmitting unit and a reflecting unit, wherein the first substrate includes a first electrode and the second substrate includes a second electrode in each of the transmitting unit and the reflecting unit for applying voltages;
first and second passive alignment layers over the first and second electrodes, respectively;
first and second ferroelectric liquid crystal alignment layers on the first and second passive alignment layers, respectively; and
a liquid crystal layer between the first and second substrates.

2. The device of claim 1, wherein one of the first and second ferroelectric liquid crystal alignment layers includes an SSFLC-based ferroelectric liquid crystal.

3. The device of claim 2, wherein the SSFLC-based ferroelectric liquid crystal includes one of a CDR (Continuously Director Rotate)-based liquid crystal, an anti-ferroelectric liquid crystal, a ferroelectric liquid crystal monomer, a ferroelectric liquid crystal polymer, and a PS(Polymer Stabilization) ferroelectric liquid crystal.

4. The device of claim 1, wherein one of the first and second passive alignment layers includes polyimide.

5. The device of claim 1, wherein the liquid crystal layer includes a negative nematic liquid crystal.

6. The device of claim 1, wherein one of the first and second electrodes includes a transparent conductive material.

7. The device of claim 5, wherein the transparent conductive material includes Indium Tin Oxide (ITO) or Indium Zinc Oxide (IZO).

8. The device of claim 1, further comprising a reflector in the reflecting unit for reflecting light.

9. The device of claim 1, wherein a first voltage is applied to the transmitting unit and a second voltage is applied to the reflecting unit, the first voltage different from the second voltage.

10. The device of claim 9, wherein the first voltage is greater than the second voltage.

11. The device of claim 1, wherein molecules of the liquid crystal layer rotate when a voltage is applied between the first and second electrodes.

12. A liquid crystal display (LCD) device comprising:
a ferroelectric liquid crystal alignment layer between first and second substrates, the first and second substrates having a pixel, the pixel having a transmitting unit and a reflecting unit;
a liquid crystal layer between the first and second substrates;
first and second electrodes in the transmitting unit for applying a first voltage to the liquid crystal layer in the transmitting unit; and
third and fourth electrodes in the reflecting unit for applying a second voltage to the liquid crystal layer in the reflecting unit, the first voltage is different from the second voltage.

13. The device of claim 12, wherein the ferroelectric liquid crystal layer is photo-cured.

14. The device of claim 12, wherein the first voltage is greater than the second voltage.

15. A liquid crystal display (LCD) device comprising:
a substrate having first and second regions;
an alignment layer including ferroelectric liquid crystal molecules, the ferroelectric liquid crystal molecules rotating by a first angle θ₁ in the first region, the ferroelectric liquid crystal molecules rotating by a second angle 02 in the second region, the first angle 0 different from the second angle 02; and
a liquid crystal layer contacting the ferroelectric liquid crystal molecules, liquid crystal molecules of the liquid crystal layer rotating according to the rotation of the ferroelectric liquid crystal molecules.

16. The device of claim 15, further comprising a reflector in the second region for reflecting light.

17. The device of claim 16, wherein the first angle is greater than the second angle (θ₁>θ₂).

18. The device of claim 17, wherein a transmittance of the first region is substantially the same as that of the second region.

19. The device of claim 15, wherein the LCD device is an IPS (In Plane Switching) mode LCD.

20. The device of claim 15, wherein the liquid crystal molecules of the liquid crystal layer rotate on a plane.

21. The device of claim 15, wherein the alignment layer includes an SSFLC-based ferroelectric liquid crystal.

22. The device of claim 21, wherein the SSFLC-based ferroelectric liquid crystal includes one of a CDR (Continuously Director Rotate)-based liquid crystal, an anti-ferroelectric liquid crystal, a ferroelectric liquid crystal monomer, a ferroelectric liquid crystal polymer, and a PS(Polymer Stabilization) ferroelectric liquid crystal.
